(19) United States
(12) Patent Application Publication
(10) Pub. No.: US 2013/0345996 A1
(43) Pub. Date: Dec. 26, 2013

(54) PROCESS LIQUID FLOWMETER

(71) Applicants: Takami Satoh, Koshi-shi (JP); Ryoji Ando, Koshi-shi (JP); Koji Uchimura, Kyoto-shi (JP)

(72) Inventors: Takami Satoh, Koshi-shi (JP); Ryoji Ando, Koshi-shi (JP); Koji Uchimura, Kyoto-shi (JP)

(73) Assignees: HORIBA ADVANCED TECHNO, CO., LTD., Kyoto-shi, Kyoto (JP); TOKYO ELECTRON LIMITED, Tokyo (JP)

(21) Appl. No.: 14/003,774

(22) PCT Filed: Feb. 15, 2012
(86) PCT No.: PCT/JP2012/053576

§ 371 Date: Sep. 6, 2013

(30) Foreign Application Priority Data
Mar. 9, 2011 (JP) 2011-052228

(51) Int. Cl. G01F 1/66

(52) U.S. Cl. CPC G01F 1/66
USPC 702/48

(57) ABSTRACT

A flowmeter of the present invention is adapted to measure a flow velocity of a process liquid flowing through a supply pipe, and includes: a pair of ultrasonic oscillators located with a spacing therebetween of a predetermined distance along a flow direction of the supply pipe; a flow velocity calculating part calculating a flow velocity of the process liquid based on a first arrival time elapsed for an ultrasonic wave generated from one of the pair of ultrasonic oscillators to arrive at the other of the pair of ultrasonic oscillators and a second arrival time elapsed for an ultrasonic wave generated from the other of the pair of ultrasonic oscillators to arrive at the one of the pair of ultrasonic oscillators; and a bubble inclusion determining part determining, based on a time-varying amount of the calculated process liquid flow velocity, whether air bubbles are included in the process liquid.

### TECHNICAL FIELD

The present invention relates to a process liquid flowmeter suitable for use with a process liquid such as a resist liquid.

### BACKGROUND ART

In a photoresist coating device of a semiconductor manufacturing apparatus, a wafer is rendered to have photosensitivity by coating a very thin photoresist uniformly on the wafer. Herein, when coating a photoresist uniformly on a wafer, if air bubbles are contained in a resist liquid, there is a problem that an uneven coating occurs so that the photoresist cannot be coated uniformly.

Therefore, conventionally, as disclosed in Patent Literature 1, there is configured to have a bubble detection part provided in a supply pipe supplying the resist liquid to the photoresist device so as to be able to automatically detect presence or absence of air bubbles in the resist liquid. In addition, in order to uniformly coat the photoresist, a current meter for measuring a flow velocity of the resist liquid and a flowmeter for measuring a flow rate of the resist liquid and the like are provided on the supply pipe.

However, if the bubble detection part is provided on the supply pipe in addition to the current meter and the flowmeter and the like, there is a problem that the configuration of the supply pipe and the peripheries thereof becomes complicated. Also, there is a problem that a maintenance task tends to be complicated, and the size may tend to increase.

### CITATION LIST

### Patent Literature

Patent Literature 1: JPA2005-136185

### SUMMARY OF INVENTION

### Technical Problem

Therefore, the present invention has been made in order to collectively solve the above problems, and an essential object thereof is to provide a process liquid flowmeter having a function of determining inclusion of air bubbles into the process liquid, a function of suitably measuring a flow velocity of various sorts of process liquids or a function of detecting a backflow of the process liquid so that the process liquid flowmeter is rendered to have various functions so as to simplify a configuration on a supply pipe.

### Solution to Problem

That is, a process liquid flowmeter according to the present invention is adapted to measure a flow velocity of a process liquid flowing through a supply pipe, wherein the process liquid flowmeter includes:

a pair of ultrasonic oscillators located with a spacing therebetween of a predetermined distance along a flow direction of the supply pipe;

a flow velocity calculating part calculating a flow velocity of the process liquid based on a first arrival time elapsed for an ultrasonic wave generated from one of the pair of ultrasonic oscillators to arrive at the other of the pair of ultrasonic oscillators and a second arrival time elapsed for an ultrasonic wave generated from the other of the pair of ultrasonic oscillators to arrive at the one of the pair of ultrasonic oscillators;

a bubble inclusion determining part determining, based on a time-varying amount of the calculated flow velocity of the process liquid, whether air bubbles are included in the process liquid; and

a flow rate calculating part calculating a flow rate based on the flow velocity calculated by the flow velocity calculating part and a cross-sectional area of the supply pipe.

With this configuration, it is possible to render the flowmeter using the ultrasonic oscillators to have a bubble inclusion determining function of determining presence or absence of air bubbles included in the process liquid. Therefore, it is not necessary to provide a bubble detection part other than the flowmeter on the supply pipe so that the configuration on the supply pipe can be simplified. In addition, since the flow velocity is calculated using the ultrasonic oscillators, it is possible to measure a minute flow rate of, for example, 15 [ml/min] or smaller.

In order to facilitate the bubble inclusion determination processing by the bubble inclusion determining part, it is preferable that, in the case where the time-varying amount exceeds a prescribed threshold, the bubble inclusion determining part determines that air bubbles are included in the process liquid.

In addition, a process liquid flowmeter according to the present invention is adapted to measure a flow velocity of a process liquid flowing through a supply pipe, wherein the process liquid flowmeter includes:

a pair of ultrasonic oscillators located with a spacing therebetween of a predetermined distance along a flow direction of the supply pipe; and

a flow velocity calculating part calculating a flow velocity of the process liquid based on a first arrival time elapsed for an ultrasonic wave generated from one of the pair of ultrasonic oscillators to arrive at the other of the pair of ultrasonic oscillators, a second arrival time elapsed for an ultrasonic wave generated from the other of the pair of ultrasonic oscillators to arrive at the one of the pair of ultrasonic oscillators, and a process liquid type. With this configuration, the flow velocity can be automatically calculated in consideration of the type of process liquid, as well.

In order to make it possible to measure a flow velocity of each of a plurality of process liquids without individually calibrating for the flow velocity of each of the process liquids, it is preferable that the flow velocity calculating part obtains a flow velocity of a prescribed standard liquid using a flow velocity calculation formula including the first and second arrival times as parameters, and further multiplies the flow velocity of the standard liquid by a coefficient predetermined for every process liquid so as to calculate the flow velocity of the process liquid.

In addition, a process liquid flowmeter according to the present invention is adapted to measure a flow velocity of a process liquid flowing through a supply pipe, wherein the process liquid flowmeter includes:

a pair of ultrasonic oscillators located with a spacing therebetween of a predetermined distance along a flow direction of the supply pipe; and

a flow velocity calculating part calculating a flow velocity of the process liquid based on a first arrival time elapsed for an ultrasonic wave generated from one of the pair of ultrasonic oscillators to arrive at the other of the pair of ultrasonic oscillators and a second arrival time elapsed for an ultrasonic wave generated from the other of the pair of ultrasonic oscillators to arrive at the one of the pair of ultrasonic oscillators, wherein

in the case where a negative value of the flow velocity is calculated by the flow velocity calculating part, it is determined that the process liquid is flowing in a reverse direction. With this configuration, it is possible to provide a process liquid flowmeter capable of appropriately detecting that the process liquid is flowing in the reverse direction in the case where a negative value of a flow velocity is calculated

### Advantageous Effects of Invention

According to the present invention configured as described above, it is possible to provide a process liquid flow meter having a function of determining inclusion of air bubbles into a process liquid, a function of appropriately measuring a flow velocity of various sorts of process liquid or a function of detecting a backflow of the process liquid. Moreover, since the flow velocity is calculated using ultrasonic oscillators, a minute flow rate can be measured.

### BRIEF DESCRIPTION OF DRAWINGS

FIG. 1 is a schematic diagram of a process liquid flowmeter of the present embodiment.

FIG. 2 is a schematic diagram showing a first arrival time and a second arrival time.

FIG. 3 is a schematic diagram showing a flow velocity with time lapse and a determination of inclusion of air bubbles.

FIG. 4 is a schematic diagram of a process liquid flowmeter of a modified embodiment.

### DESCRIPTION OF REFERENCE CHARACTERS

100 . . . Resist liquid flowmeter (process liquid flowmeter)
200 . . . Supply pipe
2 . . . One of the ultrasonic oscillators
3 . . . The other of the ultrasonic oscillators
T1 . . . First arrival time
T2 . . . Second arrival time
4 . . . Flow velocity calculating part
5 . . . Bubble inclusion determining part
6 . . . Flow rate calculating part
D1 . . . Coefficient data storage part

### DESCRIPTION OF EMBODIMENTS

A process liquid flowmeter 100 according to the present embodiment is intended to measure a flow velocity and flow rate of a resist liquid flowing through a supply pipe 200 including such as a PFA tube connected to a photoresist coating device of a semiconductor manufacturing apparatus (not shown). Herein, since the supply pipe 200 is composed of a PFA tube and there is no pressure loss such as a restriction, air bubbles are less likely to occur.

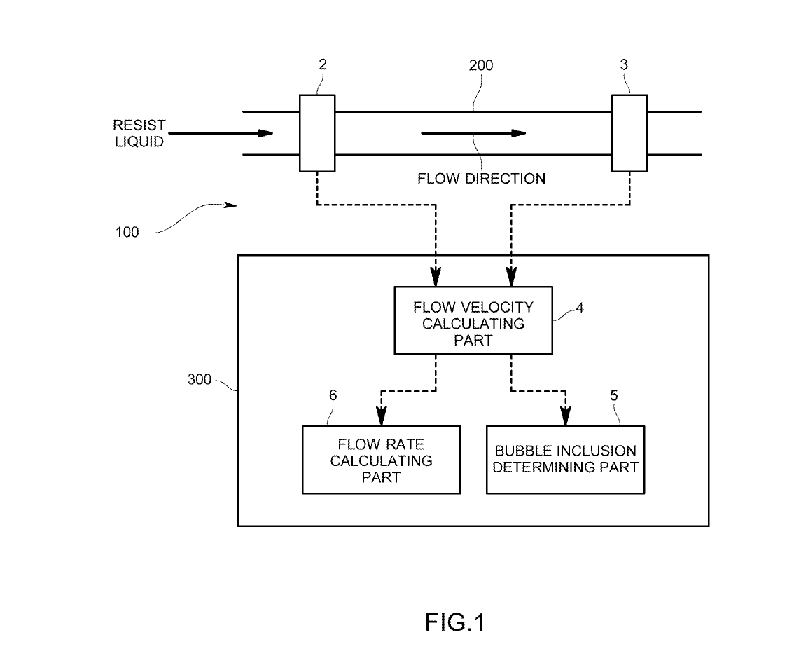

Specifically, as shown in FIG. 1, this process liquid flowmeter 100 includes: a pair of ultrasonic oscillators 2 and 3 located with a spacing therebetween of a predetermined distance along a flow direction of the supply pipe; a flow velocity calculating part 4 calculating a flow velocity of a resist liquid upon receipt of a detection signal obtained from the pair of ultrasonic oscillators 2 and 3; a bubble inclusion determining part 5 determining, based on a time-varying amount of the calculated flow velocity of the resist liquid, whether air bubbles are included in the resist liquid; and a flow rate calculating part 6 calculating a flow rate based on the flow velocity calculated by the flow velocity calculating part 4 and a cross-sectional area of the supply pipe 200.

It is noted here that the flow velocity calculating part 4, the bubble inclusion determining part 5, and the flow rate calculating part 6 include a general-purpose or dedicated so-called computer 300 equipped with a CPU, a memory, an A/D converter, a D/A converter, an input/output interface and the like so that the CPU and peripheral equipment are operated in cooperation in accordance with a predetermined program stored in the memory. Otherwise, these parts 4 to 6 may be configured using discrete circuits.

One of the pair of ultrasonic oscillators 2 provided at an upstream side is driven by a drive circuit (not shown) so as to transmit an ultrasonic wave toward the other of the pair of ultrasonic oscillators 3. Also, the one ultrasonic oscillator 2 receives an ultrasonic wave transmitted from the other ultrasonic oscillator 3. The signal received by the one ultrasonic oscillator 2 is amplified by a predetermined gain by an amplifier circuit (not shown) so as to be transmitted to the flow velocity calculating part 4.

Similarly to the one ultrasonic oscillator 2, the other ultrasonic oscillator 3 provided at a downstream side is driven by a drive circuit (not shown) so as to transmit an ultrasonic wave toward the one ultrasonic oscillator 2. Also, the other ultrasonic oscillator 3 receives an ultrasonic wave transmitted from the one ultrasonic oscillator 2. The signal received by the other ultrasonic oscillator 3 is amplified by a predetermined gain by an amplifier circuit (not shown) so as to be transmitted to the flow velocity calculating part 4.

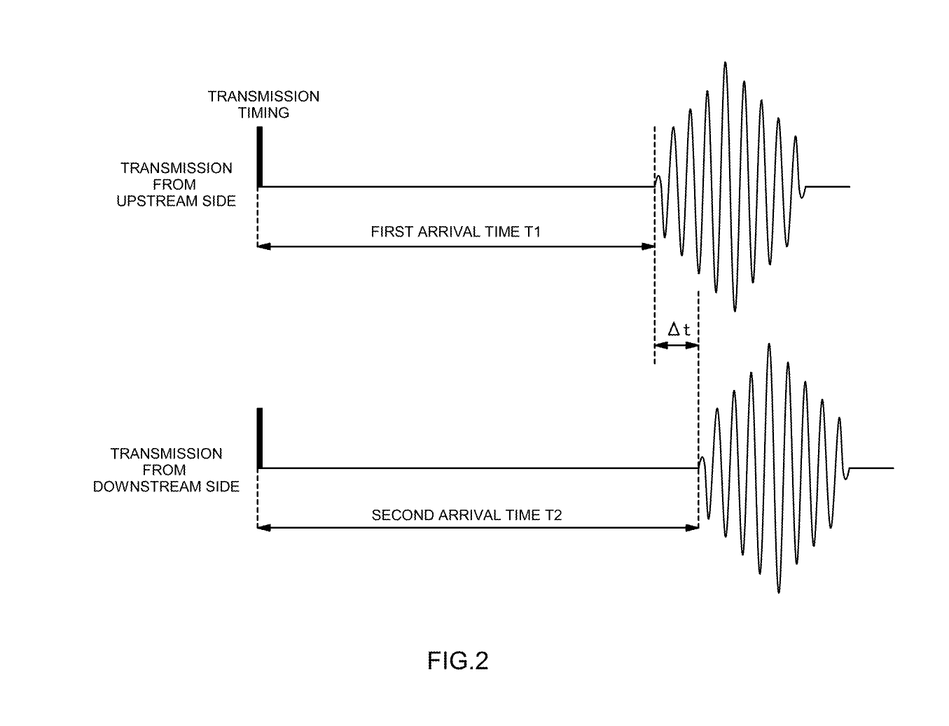

The flow velocity calculating part 4 receives the detection signals from the pair of ultrasonic oscillators 2 and 3 so as to calculate a first arrival time T1 that is a time period between a transmission timing of the ultrasonic wave generated from the one ultrasonic oscillator 2 and a receipt timing thereof received by the other ultrasonic oscillator 3, and a second arrival time T2 that is a time period between a transmission timing of the ultrasonic wave generated from the other ultrasonic oscillator 3 and a receipt timing thereof received by the one ultrasonic oscillator 2, as shown in FIG. 2. Then, the flow velocity calculating part 4 calculates the flow velocity of the resist liquid based on the first and second arrival times T1 and T2. In specific, the flow velocity calculating part 4 calculates the flow velocity V (ml/min) using Equation 1 as follows. Herein, L is a distance between the one ultrasonic oscillator 2 and the other ultrasonic oscillator 3.

$$V = \frac{L}{2} ( \frac{1}{T 1} - \frac{1}{T 2} ) = \frac{L}{2} ( \frac{T 2 - T 1}{T 1 \times T 2} ) = \frac{L}{2} ( \frac{Δ T}{T 1 \times T 2} ) \qquad [ Equation 1 ]$$

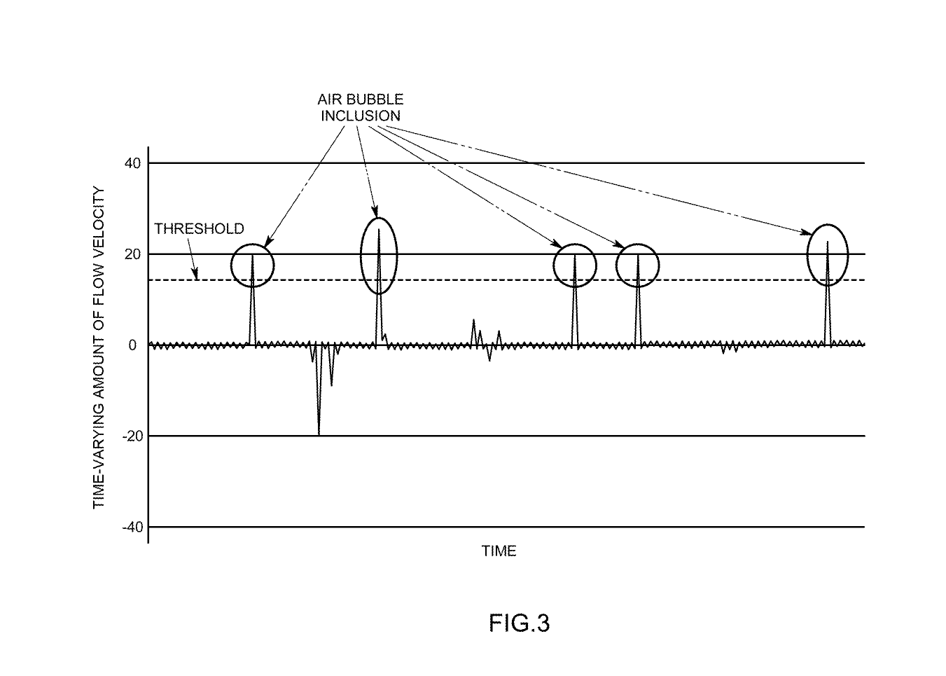

The bubble inclusion determining part 5 acquires the flow velocity data calculated by the flow velocity calculating part 4 and determines, based on a time-varying amount of the calculated flow velocity, whether or not air bubbles are included in the resist liquid. Specifically, as shown in FIG. 3, in the case where the time-varying amount of an instantaneous value of the flow velocity exceeds a prescribed threshold, the bubble inclusion determining part 5 determines that air bubbles are included in the resist liquid.

The flow rate calculating part 6 calculates the flow rate based on the flow velocity calculated by the flow velocity calculating part 4 and a cross-sectional area of the supply pipe 200. In specific, the flow rate calculating part 6 calculates the flow rate from a following equation:

Flow rate Q(L/min)=60×V×S×k[L/min]

Herein, S is a cross-sectional area of a flow path of the supply pipe 200, and k is a correction factor (correction coefficient) (i.e., correction value of a flow path diameter of the supply pipe and the distance between the pair of ultrasonic oscillators, etc.).

### Effect of the Present Embodiment

According to the resist liquid flowmeter 100 according to the present embodiment configured as described above, it is possible to render the flowmeter using the ultrasonic oscillators 2 and 3 to have a bubble inclusion determining function of determining presence or absence of air bubbles included in the resist liquid. Therefore, it is not necessary to provide a bubble detection part other than the flowmeter 100 on the supply pipe 200 so that the configuration on the supply pipe 200 can be simplified and it becomes possible to determine the inclusion of air bubbles without complicating maintenance tasks and without incurring an increase in size of the apparatus. In addition, since the flow velocity is calculated using the ultrasonic oscillators 2 and 3, it is possible to measure a minute flow rate of, for example, 15 [ml/min] or smaller.

### Other Modified Embodiment

It is noted that the present invention is not limited to the embodiment described above.

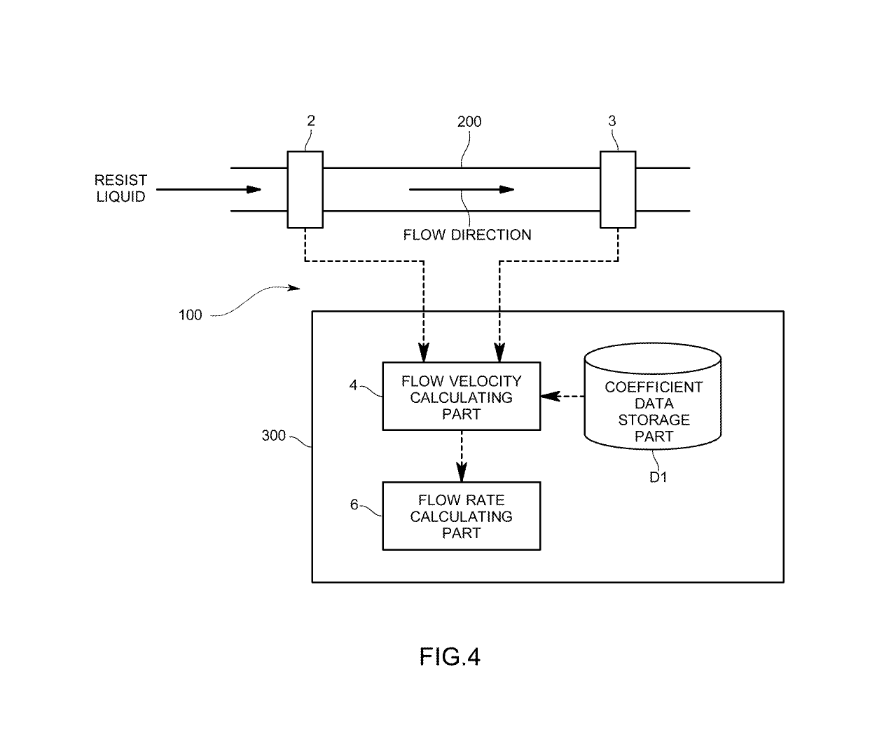

For example, the flow velocity calculating part 4 of the above embodiment may be configured to calculate the flow velocity of the resist liquid based on the first arrival time T1 and the second arrival time T2 and a type of the resist liquid. In this case, as shown in FIG. 4, the process liquid flowmeter 100 includes a coefficient data storage part D1 for storing coefficient data indicative of a coefficient that is determined from values of physical properties and the like of each resist liquid with respect to the standard liquid. Thus, the flow velocity calculating part 4 obtains a flow velocity of the prescribed standard liquid using a flow velocity calculation formula including the first and second arrival times T1 and T2 as parameters and further multiplies the flow velocity of the standard liquid by the coefficient predetermined for each of the resist liquids using the coefficient data acquired from the coefficient data storage part D1 so as to calculate the flow velocity of the resist liquid.

In addition, the flow velocity calculating part of the above embodiment may be also configured that, in the case where the flow velocity calculating part calculates a negative value of the flow velocity, it is determined that the resist liquid is flowing in a reverse direction.

Furthermore, although it is intended to measure a flow rate of a resist liquid as a process liquid in the above embodiment, it may be configured to measure a flow rate of other liquid such as an etching liquid.

In addition, it is needless to say that the present invention is not limited to the above embodiments and various modifications thereof can be made in a range without departing from the spirit thereof.

### Industrial Applicability

According to the present invention, it becomes possible to provide a process liquid flowmeter having a function of determining inclusion of air bubbles into the process liquid, a function of suitably measuring a flow velocity of various sorts of process liquids or a function of detecting a backflow of the process liquid so that the process liquid flowmeter is rendered to have various functions so as to simplify a configuration on a supply pipe process.

1. A process liquid flowmeter adapted to measure a flow velocity of a process liquid flowing through a supply pipe, comprising:
a pair of ultrasonic oscillators located with a spacing therebetween of a predetermined distance along a flow direction of the supply pipe;
a flow velocity calculating part calculating a flow velocity of the process liquid based on a first arrival time elapsed for an ultrasonic wave generated from one of the pair of ultrasonic oscillators to arrive at the other of the pair of ultrasonic oscillators and a second arrival time elapsed for an ultrasonic wave generated from the other of the pair of ultrasonic oscillators to arrive at the one of the pair of ultrasonic oscillators;
a bubble inclusion determining part determining, based on a time-varying amount of the calculated flow velocity of the process liquid, whether air bubbles are included in the process liquid; and
a flow rate calculating part calculating a flow rate based on the flow velocity calculated by the flow velocity calculating part and a cross-sectional area of the supply pipe.

2. The process liquid flowmeter according to claim 1, wherein, in a case where the time-varying amount exceeds a prescribed threshold, the bubble inclusion determining part determines that air bubbles are included in the process liquid.

3. A process liquid flowmeter adapted to measure a flow velocity of a process liquid flowing through a supply pipe, comprising:
a pair of ultrasonic oscillators located with a spacing therebetween of a predetermined distance along a flow direction of the supply pipe; and
a flow velocity calculating part calculating a flow velocity of the process liquid based on a first arrival time elapsed for an ultrasonic wave generated from one of the pair of ultrasonic oscillators to arrive at the other of the pair of ultrasonic oscillators, a second arrival time elapsed for an ultrasonic wave generated from the other of the pair of ultrasonic oscillators to arrive at the one of the pair of ultrasonic oscillators and a type of the process liquid.

4. The process liquid flowmeter according to claim 3, wherein the flow velocity calculating part obtains a flow velocity of a prescribed standard liquid using a flow velocity calculation formula including the first and second arrival times as parameters and further multiplies the flow velocity of the standard liquid by a coefficient predetermined for every process liquid so as to calculate the flow velocity of the process liquid.

5. A process liquid flowmeter adapted to measure a flow velocity of a process liquid flowing through a supply pipe, comprising:
a pair of ultrasonic oscillators located with a spacing therebetween of a predetermined distance along a flow direction of the supply pipe; and
a flow velocity calculating part calculating a flow velocity of the process liquid based on a first arrival time elapsed for an ultrasonic wave generated from one of the pair of ultrasonic oscillators to arrive at the other of the pair of ultrasonic oscillators and a second arrival time elapsed for an ultrasonic wave generated from the other of the pair of ultrasonic oscillators to arrive at the one of the pair of ultrasonic oscillators, wherein
in a case where a negative value of the flow velocity is calculated by the flow velocity calculating part, it is determined that the process liquid is flowing in a reverse direction.
